(19) United States
(12) Patent Application Publication
(10) Pub. No.: US 2003/0071734 A1
(43) Pub. Date: Apr. 17, 2003

(54) Method and apparatus for remote monitoring and control of a target group

(76) Inventor: George M. Vodin, Barrington, IL (US)

Correspondence Address: BABCOCK IP LLC, 24154 LAKESIDE DRIVE, LAKE ZURICH, IL, 60047, US

(21) Appl. No.: 10/065,156

(22) Filed: Sep. 23, 2002

Related U.S. Application Data
(60) Provisional application No. 60/325,606, filed on Sep. 28, 2001.

(51) Int. Cl. G08B 23/00

(52) U.S. Cl. 340/573.1; 600/300

(57) ABSTRACT

A method and apparatus for remote monitoring and control of a target group. An armband located on each user may be enabled upon entry to a secured area by passing thru an electronic gateway. The armband transmits user physiological data to a linked central control console where a security monitor or Marshal has the ability to remotely activate delivery of an immobilizing dosage of a, for example, anesthetic from the armband(s) of a selected individual or group of users. To prevent tampering, the armband may be configured to deliver an immobilizing dosage if it detects. attempts to remove, isolate or otherwise disable the armband. Upon exiting from the secured area, the device may be disabled by again passing through an electronic gateway.

### CROSS REFERENCE TO RELATED APPLICATIONS

This application claims the benefit of U.S. Provisional Application No. 60/325,606, filed Sep. 28, 2001.

### BACKGROUND OF INVENTION

1. Field of the Invention

The invention generally relates to a method and apparatus for remote monitoring and control of a target group. Specifically, the invention relates to automatic and remote security for areas where a non-restraining form of security is required of individuals and/or a target group. An unobtrusive, non-restraining remote and/or automatically controlled immobilizing device is fitted to each individual prior to entry to a secure area.

2. Description of Related Art

Previously, security has been provided by barriers, physical restraints and/or an armed security entity. Physical restraints are generally culturally unacceptable for use upon the public. Barriers permit isolation of the target group but do not allow for control of an individual within the area who may have the potential for harming others within the secured area. Armed security may be inappropriate in enclosed areas such as an airplane. In a panic, it would be difficult to isolate the attacker from the bystanders. Common weaponry usable for targeting an individual such as a common sidearm or other projectile weapon may be hazardous to bystanders and or the airframe. Further, these forms of restraint permit the attacker several seconds or even minutes of action prior to becoming immobilized where the attacker may have great opportunity for damage and harm to others. Where a large group must be restrained simultaneously, a single security officer with a weapon may be quickly overwhelmed and security thereby compromised. Where potentially lethal force must be used to restrain individuals or groups, a secure area may be far removed from medical facilities resulting in unnecessary deaths of the individuals who have been injured by the security officer or an unrestrained attacker(s). For example a gun shot or knife wound that is non-lethal may become lethal before an airliner is able to land and deliver the injured to medical facilities.

Even where a barrier with a security officer is used, hostage taking may induce the security officer to surrender his or her weapon and/or access out of the secured area. Human emotion limits a rigid application of a predefined security protocol.

It is an object of the present invention to solve these and other problems that will become clear to one skilled in the art upon review of the following specification.

### SUMMARY OF INVENTION

A remote monitoring and control method and apparatus useful to secure individuals within an area without undue restriction of freedom of movement, unreasonable search or user discomfort. An armband located on each user may be enabled upon entry to a secured area by passing thru an electronic gateway. The armband transmits user physiological data to a linked central control console where a security monitor or Marshal has the ability to remotely activate delivery of an immobilizing dosage of a, for example, anesthetic from the armband(s) of a selected individual or group of users. To prevent tampering, the armband may be configured deliver an immobilizing dosage if it detects attempts to remove, isolate or otherwise disable the armband. Upon exiting from the secured area, the device may be disabled by again passing through an electronic gateway. In other embodiments, the method and apparatus may be used, for example, for central monitoring having the capability for remote controlled and or automatic medication of individual or groups of patients without restricting their freedom of movement.

### BRIEF DESCRIPTION OF DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a diagram showing location of the armband in use.

FIG. 2 is an external end view of the armband.

FIG. 3 is an external side view of the armband.

FIG. 4 is a cut away view of the operating module.

FIG. 5 is a flow chart describing a typical sequence of operation for the invention.

### DETAILED DESCRIPTION

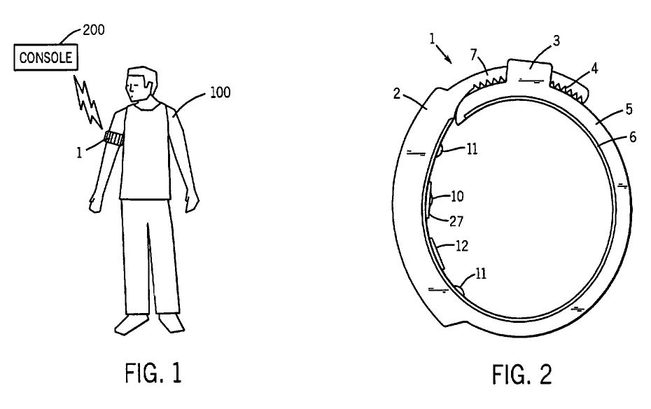

In one embodiment, as shown in FIG. 1, an armband 1 is worn by users admitted to a secured area. Each user 100 is issued an armband 1 having a communication link to a console 200. The armband 1 is preferably fitted to the user”s arm between the shoulder and elbow, above the biceps. Location of the armband 1 upon the upper arm permits the armbands” 1 easy semi-permanent attachment and is an injection point close to the wearer”s vital organs allowing expedited delivery of a desired drug. Other locations of the armband may be about the neck, upon the wrists, ankles and/or legs. In other embodiments the armband may be in the form of a belt or vest with sensor and/or injection modules located upon the body and interconnected with the belt or vest.

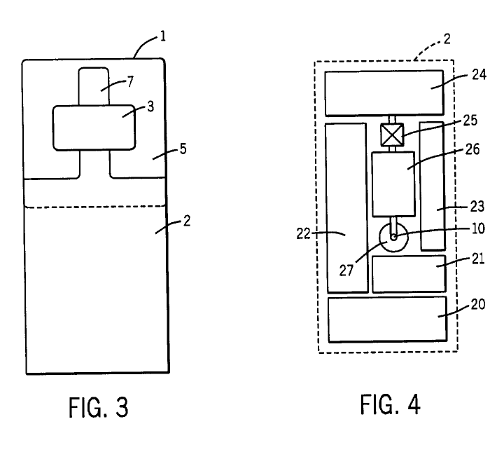

As shown in FIGS. 2 and 3, the armband 1 consists of a band 5 which snuggly encircles the wearer”s extremity. The band 5 closes via a locking mechanism 3 which retains, for example, a tongue 7 of the band 5 with a saw-tooth retaining pattern 4 which securely engages a locking mechanism 3. Other retaining patterns 4 may include holes, slots, ribs or other surfaces that will permit secure engagement with the locking mechanism 3. The locking mechanism 3 may be any form of secure attachment. For example, a solenoid mechanism with a lock, locking piston or cam to securely engage/disengage individual teeth of the retaining pattern 4 upon the tongue 7. A locking mechanism 3 and retaining pattern 4 combination that allows the armband 1 to adapt to different sized extremities, reduces the number of discrete sizes of armband 1 required for the expected user population.

The armband 1 may include any combination of a plurality of sensors. For example, a ribbon sensor 6 may extend around either outside edge of the band 5 sensing the users pulse rate, blood pressure and other vital signs. The ribbon sensor 6 output signals enabling detection and alarm if any attempt is made to disable or isolate the armband 1 from contact with the user 100. For example, if a shield is attempted to be inserted between the user 100 and the armband 1 to interrupt the injector”s 10 contact with the user”s skin, the ribbon sensor 6 may be configured to detect changes in the sensor”s body resistance beyond a present fixed range and initiate an alarm to the console and/or trigger a drug application. Other sensors, for example conductivity sensors 11 may detect changes in the users skin surface moisture levels and provide a redundant continuity check that the armband 1 remains in place. Temperature sensors 27 may report user temperature and also monitor contact thereby with the users arm. Another sensor input may be a proximity and/or spring switch 12 that changes state if contact with the user”s arm is lost.

An operating module 2, as shown in FIG. 4, contains the operating/logic components of the armband 1. The sensors and locking mechanism may be monitored/controlled by the operating module 2. Within the operating module 2 is housed a power source 20, for example a battery. The battery energizes CPU/logic/memory circuitry 22 as well as the sensor array 23, radio transceiver 21 and a trigger valve 25. The trigger valve 25, when activated by a signal from the CPU, releases the propellant, stored in a propellant chamber 24, for example compressed air or other gas, through a drug chamber 26 driving the drug therein to the injector assembly 27 which delivers the drug through the injector 10 into the user 100. Alternatively, the propellant chamber 24 may be replaced with a spring plunger mechanism. Injection may occur, for example, via a hypodermic, spring needle or a skin penetrating high pressure spray nozzle, as used in common mass inoculation pneumatic injectors.

The CPU/logic/memory 22 monitors the various sensors and transmits the armband”s current status and the users physiological data through the radio transceiver 21 to the console 200 which may be local to but separated from the secure area, for example in the cockpit or a secure flight marshal or flight attendant station of an airliner. The console 200 may be configured to automatically relay higher-level alarms to a remote central authority, for example a national Federal Aviation Administration or Homeland Security watch desk.

The CPU/logic/memory 22 may be configured in a fail-safe manner wherein disruption of one or more base line inputs from the sensor array 23 will result in immediate activation of the trigger valve 25. The steady state of the base line inputs may include presence of a radio/data link verified within a minimum preset time interval through the transceiver 21 with the console 200.

Communication Protocols for the data link between the radio transceiver 21 and the console 200 may include, for example, Bluetooth, 802.11 a or b, Home RF and/or other proprietary protocols. Encryption, for example, blow fish protocol, may be used to prevent tampering with or spoofing of the data link. Error correction/detection protocols may be used to allow continued operation of the data link despite transient radio noise/interference. Active or passive RFID tags may be used for low power consumption communication with and automatic enabling and or activation of higher level functions upon detection of the armband 1 when passing through radio gateways.

Signals to and from the transceiver 21 are picked up by an antenna or antenna array located in and around the secure area. If desired, triangulation information from discrete console antennas/receivers allowing calculation of the exact location of the armband in the secure area may be collected and transmitted to the console 200. Each armband may have a unique identification number embedded within the CPU/logic/memory 22 allowing discrete communication with the console 200 and reception from the console 200 of specific armband status information. A console operator or Marshal has the ability, via the console 200 to view the parameters of any armband within the secure area. Armbands 1 passing through radio gateway barriers, for example past the passenger area of an airplane towards the cockpit or other critical areas, may be configured to automatically activate a drug injection. Also, a single armband 1 that is losing electrical power, measured by the battery 20 voltage falling below a preset level or that looses the data link with the master console may be configured to alarm and or activate the immobilizing drug prior to or as a consequence of losing the ability to communicate and/or activate the trigger valve 25.

Drugs usable with the armband are stored in the drug chamber 26. In a security embodiment, the drug may comprise an anesthetic or other drug combination capable of immobilizing the armband wearer for a desired period, for example, approximately ten to twelve minutes. Care is taken to prevent a drug overdose upon the user, however, a balance may be made between fast drug action and total user safety in the name of overall security. Anesthetic drugs may include Sodium Pentothal, Propofol, Mexo Hetatol, Etomidate and/or Ketamine. Any of these anesthetic drugs except Ketamine may stop breathing in the event of a drug overdose. Proper dosages are determined by an analysis of gender, body structure and weight of the intended user. Bands may be color coded, indicating a preloaded dosage or individual anesthetic containers may be loaded at the time of use depending upon the user”s parameters.

Materials for the armband may be any that provides for secure attachment and isolation of the sensors and operating module from user tampering. Materials include synthetics, plastic and/or metal with kevlar material preferred as an outer layer as it is a flexible yet cut and tear resistant material without excess weight. At suitable thickness, Kevlar”s bullet proof properties would also resist sudden armband deactivation or removal attempts.

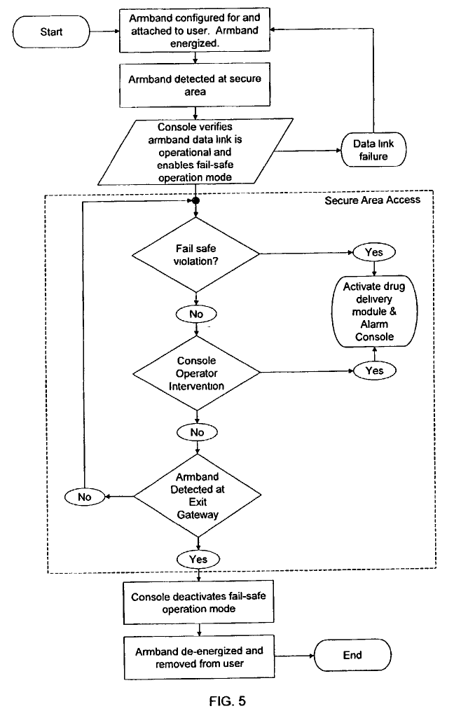

In use, for example in a secure access area embodiment as shown by the flow chart in FIG. 5, an armband 1 is configured for each individual user desiring secure area access. The armband 1 is available in a number of sizes to accommodate gender, weight and body structure and is selected to comfortably fit, for example over the users arm or other extremity and at the same time provide a safely immobilizing dosage of an anesthetic/immobilizing drug should activation become necessary. The user 100 is instructed as to the operation of the armband and once the user passes through a, for example, manual or radio gateway the armband is manually or automatically activated, a data link with the console 200 verified and the CPU/logic/memory 22 then enabled in a failsafe mode to administer the immobilizing anesthetic dosage if any pre-selected states occur. Pre-selected states may include, for example, passage into out of bounds areas and or gateways, a manual activation from the console 200, armband 1 tamper alarms, loss of data link with the console 200 and or low battery power. Operating parameters may be selected wherein a change in the users physiology, for example blood pressure and/or pulse, beyond an acceptable range will result in console notification. Alarms may also be set to identify armbands experiencing change of state beyond an acceptable preset parameter or parameter combination. High level alarms may be configured for failsafe operation where the trigger valve 25 is activated simultaneously with console 200 alarm. notification. A switch or switch array on the console 200 may be used to activate trigger valve 25 on single, multiple or all armbands within a secure area simultaneously. Armband 1 activation by the console operator may be based upon the operator”s individual perception of the circumstances as a last, human intuitive level of security.

The users physiological profile, monitored by the armband sensor array 23 is regularly transmitted to the console 200 for monitoring. The console 200 returning a steady state signal that confirms monitoring is occurring and that activation is enablable by the console 200. Upon authorized exit through a, for example, manual or radio gateway the armband may be deactivated and the locking mechanism 3 disabled to allow armband 1 removal by security staff.

The apparatus and method of the present invention may be integrated with other levels of security. For example, user photo recognition systems may be used at the entry/exit gateways to provide a check that the ticketed user is in fact the person associated with the ticket being used to gain entry to the secure area. The photo record taken at the gateway may be configured to appear at the console 200 upon an alarm in the associated armband 1. The photo record may be used to provide a quick visual association for the console operator that investigates a low level alarm, allowing him or her to quickly recognize the correct user among a sea of faces. Further, the photo record may be supplemented by gender and or seat assignment data.

For some users, it may not be possible to safely use the armband 1. Infants, elderly or others for whom the armband”s actuation may represent a significant health threat or to whom the armband 1 may not be securely fitted may forgo use of the armband 1 and opt to enter a policed section of the secure area, for example a separate section with a physical barrier isolating the occupants from the armband 1 monitored/secured occupants. Costs for a separate physical restraint section and any required human monitoring of the occupants may be levied on the occupants in the form of a surcharge.

Further applications of the armband are for medical monitoring within a hospital environment. For example, the armband may be used to monitor life signs and location of individual patients. Gateways identifying separate areas or multiple console antennas/receivers and a triangulation algorithim may be used may be used to track a user”s 100 location over a large area. In this embodiment selected patients armbands may be configured to allow a large degree of freedom while at the same time providing instant status checks and location of any patient, for example, whose vital signs have exceeded preset limits requiring instant application of a medication/drug carried in the armband.

The present invention may also be used for individual or group security/restraint, for example, with prisoners attending court or in penal institution communal prisoner areas. By adding high voltage pulse circuitry, commonly found in tasers or cattle prods, a guard with a remote control may have the ability to monitor the individual prisoners physiology, sudden actions and/or movement out of a proscribed area and apply, for example, warning electric shocks prior to activating the trigger valve and immobilizing the wearer if necessary.

[t1]

Table of Parts

| | |
|---|---|
| 1 | armband |
| 2 | operating module |
| 3 | locking mechanism |
| 4 | retaining pattern |
| 5 | band |
| 6 | ribbon sensor |
| 7 | tongue |
| 10 | injector |
| 11 | conductivity sensor |
| 12 | spring switch |
| 20 | power source |
| 21 | radio transceiver |
| 22 | CPU/logic/memory circuitry |
| 23 | sensor array |
| 24 | propellant chamber |
| 25 | trigger valve |
| 26 | drug chamber |
| 27 | injector assembly |
| 100 | user |
| 200 | console |

Where in the foregoing description reference has been made to ratios, integers, components or modules having known equivalents then such equivalents are herein incorporated as if individually set forth.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures be made from such details without departure from the spirit or scope of applicant”s general inventive concept. Further, it is to be appreciated that improvements and/or modifications may be made thereto without departing from the scope or spirit of the present invention as defined by the following claims.

1. A device for remote monitoring of a user, comprising:
an operating module configured to be removably attachable to the user;
a sensor array configured to monitor at least one physiological parameter of the user; and
a drug delivery module containing a drug, controlled by the operating module; the operating module receiving an input representative of the at least one physiological parameter of the user from the sensor array; whereby upon receiving the input beyond a desired value, the operating module activates the drug delivery module to deliver the drug to the user.

2. The device of claim 1, further including a radio transceiver.

3. The device of claim 2, further including a radio communication link monitoring circuit;
the operating module configured to one of alarm and activate the drug delivery module to deliver the drug to the user if one of the communication link is lost for a desired interval and an activation command is received.

4. The device of claim 1, wherein the sensor array is configured to detect at least one of an unauthorized removal from the user and an attempted deactivation of the operating module.

5. The device of claim 1, further including an electrical shock module; the electrical shock module operable to deliver an electrical shock to the user.

6. The device of claim 1, wherein the drug and the desired dose is selected to immobilize the user.

7. The device of claim 6, wherein the drug contains one of sodium pentothal, propofol, mexo hetatol, etomidate and ketamine.

8. A system for remote monitoring of a user, comprising:
an armband removably attachable to the user;
the armband having a sensor array configured to monitor at least one physiological parameter of the user, a drug delivery module containing a drug, an operating module receiving an input representative of the at least one physiological parameter of the user from the sensor array and transmitting it via a first radio transceiver; and
a console in wireless communication with the armband;
the console having a second radio transceiver in a communications link with the first radio transceiver and receiving the at least one physiological parameter of the user; the console having an alarm initiated if the physiological parameter of the user exceeds a desired value; an operator input at the console is operable to activate the drug delivery module, delivering the drug to the user.

9. The system of claim 8, wherein the armband is a plurality of armbands; each of the plurality of armbands removably attached to a different user.

10. The system of claim 9, wherein each of the plurality of armbands has a unique identifier and the communications link is a plurality of communications links between each of the plurality of armbands and the console.

11. The system of claim 10, further including at least one radio gateway.

12. The system of claim 11, wherein passage through the at least one radio gateway one of activates and deactivates the communications link with the console.

13. The system of claim 11, wherein passage through the at least one radio gateway activates the drug delivery module, delivering the drug to the user.

14. The system of claim 10, wherein the plurality of armbands are attached to occupants of a restricted space.

15. A method for monitoring a user, comprising the steps of:
attaching an armband to the user; the armband having an operating module receiving at least one input from a sensor array configured to monitor at least one physiological parameter of the user; and a drug delivery module containing a drug, controlled by the operating module;
activating a communications link between the armband and a console; the console receiving data from the armband representing the at least one physiological parameter of the user;
initiating an alarm at the console if the at least one physiological parameter has a pre-selected value;
transmitting a signal from the console to the armband; the signal activating the drug delivery module to deliver the drug to the user.

16. The method of claim 15, further including the step of activating the drug delivery module if one of the communications link is lost for a time interval and an unauthorized removal of the armband from the user is detected by the sensor array.

17. The method of claim 15, further including the step of establishing the communications link by passage of the armband through a radio gateway.

18. The method of claim 17, further including the steps of capturing an image of the user upon passage through the radio gateway and displaying the image at the console when the alarm exists.

19. The method of claim 18, further including the step of displaying user gender and seat assignment information with the image.

20. The method of claim 15, further including the step of determining a desired drug dosage for the user prior to attaching the armband.
